(19) United States
(12) Patent Application Publication
(10) Pub. No.: US 2013/0095739 A1
(43) Pub. Date: Apr. 18, 2013

(54) AIR CONDITIONING SYSTEM FOR VEHICLE

(71) Applicants: Yoon Hyung Lee, Gunpo-si (KR); Tae Yong Park, Daejeon (KR)

(72) Inventors: Yoon Hyung Lee, Gunpo-si (KR); Tae Yong Park, Daejeon (KR)

(73) Assignees: Hyundai Motor Company, Seoul (KR); Halla Climate Control Corp., Daejeon (KR); Kia Motors Corp., Seoul (KR)

(21) Appl. No.: 13/487,635

(22) Filed: Jun. 4, 2012

(30) Foreign Application Priority Data
Oct. 17, 2011 (KR) 10-2011-0106000

(51) Int. Cl. B60H 1/24

(52) U.S. Cl. 454/143

(57) ABSTRACT

A vehicular air conditioning system may include a cam plate rotatably coupled to an air conditioning case via a cam shaft, wherein a portion of the cam plate may be connected to a regulating knob via a cable for selecting an air conditioning mode and wherein a portion of the cam plate may be integrally formed with a cam pivot projecting toward the air conditioning case, and an arm rotatably coupled to the air conditioning case via a door shaft and formed with a guide slot into which the cam pivot may be inserted, wherein the arm may be configured to rotate about the door shaft while the cam pivot pushes a portion of the guide slot as the cam plate rotates.

### CROSS-REFERENCE TO RELATED APPLICATIONS

The present application claims priority to Korean Patent Application No. 10-2011-0106000 filed on Oct. 17, 2011, the entire contents of which is incorporated herein for purposes by this reference.

### BACKGROUND OF THE INVENTION

1. Field of the Invention

The present invention relates to a vehicular air conditioning system, and more specifically, relates to a vehicular air conditioning system which can be driven by directly connecting a cam plate and a lever arm.

2. Description of Related Art

Generally, as illustrated in FIG. 1, a control panel 1 for controlling an air conditioning system is provided in an instrument panel of a vehicle. The control panel 1 is provided with a regulating knob 2 for selecting an air conditioning mode.

The front surface of the regulating knob 2 has symbols formed on it that correspond to each of the air conditioning modes. For example, the symbols can include a Max A/C mode, a Vent mode, a Bi-level mode, a Floor mode, a Mix mode, a Defrost mode and a Mode off. A passenger can rotate the regulating knob 2 to select the desired air conditioning mode.

Meanwhile, as illustrated in FIGS. 1 and 2, in a case of a structure in which an operation for selecting the air conditioning mode is mechanically performed, the regulating knob 2 and the cam plate 3 are connected to each other via a cable 4.

The cam plate 3 is rotatably coupled with an air conditioning case 6 via a cam shaft 5. The cam plate 3 is formed with a guide slot 7 into which a lever pin 9 included in a lever 8 is inserted. One end of the lever 8 is rotatably coupled with the air conditioning case 6 via a lever shaft 10.

The other end of the lever 8 is rotatably coupled with one end of an arm 12 via the connecting pin 11. The other end of the arm 12 is rotatably coupled with the air conditioning case 6 via a door shaft 13. The door shaft 13 is integrally coupled with a door 15 which corresponds to each of the air conditioning modes and determines an opening degree of a vent hole 14 included in the air conditioning case 6.

Accordingly, as the regulating knob 2 is operated to transmit an operating force via the cable 4, the cam plate 3 rotates. Owing to the rotation of the cam plate 3, the lever pin 9 rotates the lever 8 while performing a camming action along a curvature of the guide slot 7. Also, as the rotation of the lever 8 causes the arm 12 to rotate, thereby causing the door shaft 13 and the door 15 to move, it is possible to use the door 15 to regulate the opening degree of the vent hole 14.

However, in the conventional air conditioning system configured as mentioned above, since a rotational force of the cam plate 3 is transmitted to the arm 12 via the lever 8, there are the disadvantages of the power transmitting route becoming more complicated due to a usage of the lever 8 and in particular, friction increasing the lost quantity of transmitted power.

Further, since the lever 8 is used as an intermediate medium, there is the disadvantage of the number of used parts increasing, and the weight and price thereof increasing.

It is to be noted that the prior art provided as background art is only intended for illustrative purposes and should not be construed as technologies well-known to those skilled in the art.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a vehicular air conditioning system in which a cam plate configured to receive an operational force from a regulating knob and an arm configured to rotate a door are directly connected to each other. With this configuration, it is possible to minimize the route over which power is transmitted from the regulating knob to the arm. Further, it is possible to minimize the quantity of transmitted power that is lost. In addition, it is possible to reduce the number of parts that are used, the weight, and the price thereof.

In an aspect of the present invention, a vehicular air conditioning system may include a cam plate rotatably coupled to an air conditioning case via a cam shaft, wherein a portion of the cam plate is connected to a regulating knob via a cable for selecting an air conditioning mode and wherein a portion of the cam plate is integrally formed with a cam pivot projecting toward the air conditioning case, and an arm rotatably coupled to the air conditioning case via a door shaft and formed with a guide slot into which the cam pivot is inserted, wherein the arm is configured to rotate about the door shaft while the cam pivot pushes a portion of the guide slot as the cam plate rotates.

The arm may include a central part to which the door shaft is coupled, and a first leg and a second leg which branch off from the central part, and wherein the guide slot extends from an end of the first leg in a longitudinal direction of the first leg to an end of the second leg along a longitudinal direction of the second leg.

The guide slot may include a first door idling section formed in an arc shape to may have a constant curvature along the longitudinal direction of the first leg, a second door idling section formed in an arc shape to may have a constant curvature along the longitudinal direction of the second leg, and a cam pivot seating groove recessing from a connecting part of the first door idling section and the second door idling sections toward the central part.

The size of the cam pivot seating groove is set to allow the cam pivot to be inserted therein, and wherein the cam pivot is selectively received in the cam pivot seating groove in accordance with a rotation angle of the cam shaft.

The first leg and the second leg branch off in opposite directions from the central part with a predetermined angle therebetween.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating an air conditioning system in which a regulating knob and a cam plate are connected to each other via a cable.

FIG. 2 is a view illustrating a conventional air conditioning system.

FIG. 3 is a view illustrating an air conditioning system in which a cam plate and an arm are directly connected to each other, according to an exemplary embodiment of the present invention.

FIG. 4 is a view explaining a configuration of the arm in the air conditioning system according to an exemplary embodiment of the present invention.

FIG. 5 is a view illustrating a rotational state of the arm in accordance with a rotation of the cam plate in the air conditioning system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the vehicular air conditioning system according to the exemplary embodiment of the present invention will be described in detail by referring to the accompanying drawings.

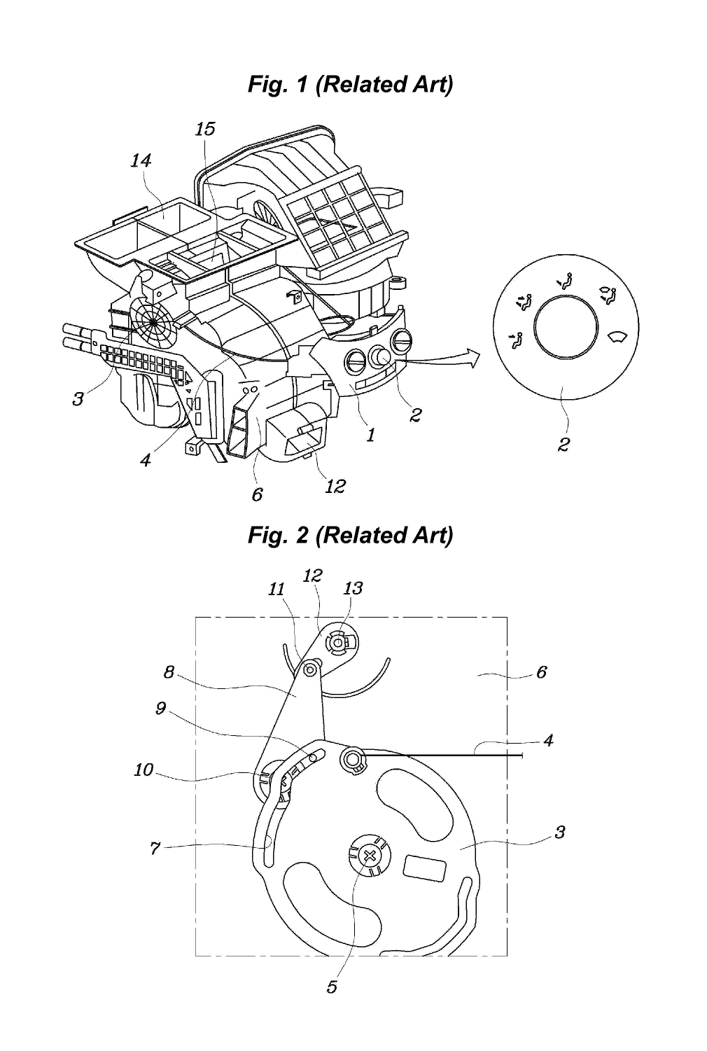

As illustrated in FIG. 1, a control panel 1 for controlling an air conditioning system is provided in an instrument panel of a vehicle. The control panel 1 is provided with a regulating knob 2 for selecting an air conditioning mode.

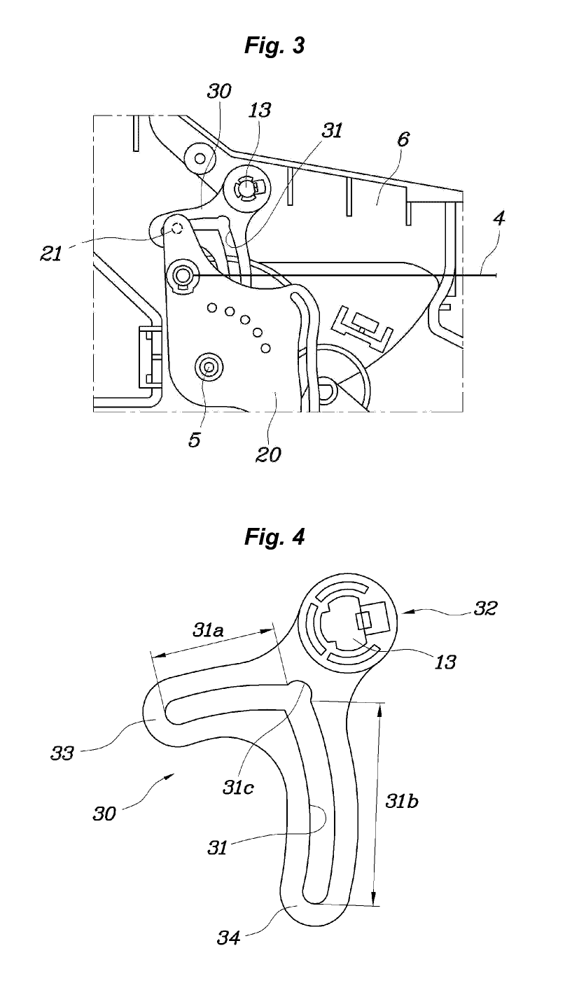

As shown in FIG. 3, the regulating knob 2 is connected to a cam plate 20 according to an exemplary embodiment of the present invention via a cable 4. The cam plate 20 is rotatably coupled with an air conditioning case 6 via a cam shaft 5. The cam plate 20 is integrally formed with a cam pivot 21 projecting toward the air conditioning case 6.

Further, an arm 30 according to an exemplary embodiment of the present invention is rotatably coupled to the air conditioning case 6 via a door shaft 13. As shown in FIG. 1, a door 15 which corresponds to each of the air conditioning modes and determines the extent to which a vent hole 14 included in the air conditioning case 6 opens is integrally coupled to the door shaft 13.

Meanwhile, the arm 30 is formed with a guide slot 31 into which a cam pivot 21 is inserted and thus the cam plate 20 is directly connected to the arm 30.

The arm 30 includes a central part 32 to which the door shaft 13 is coupled and a first leg 33 and a second leg 34 which branch off from the central part 32. The guide slot 31 extends from an end of the first leg 33 to an end of the second leg 34 along the longitudinal direction of the first and second legs 33, 34.

Herein, the first leg 33 and the second leg 34 branch off in opposite directions from the central part 32. In particular, the first leg 33 and the second leg 34 branch off from the central part 32 to form a “<” shape.

Further, the guide slot 31 includes a first door idling section 31a formed in an arc shape to have a constant curvature along the longitudinal direction of the first leg 33, a second door idling section 31b formed in an arc shape to have a constant curvature along the longitudinal direction of the second leg 34, a cam pivot seating groove 31c recessing from a connecting part of the first door idling section 31a and the second door idling sections 31b toward the central part 32. In addition, the size of the cam pivot seating groove 31c is set to allow the cam pivot 21 to be inserted therein.

Meanwhile, in a mechanical air conditioning system of which an operation is performed by a cable 4 as mentioned above, an operational variation due to an inherent feature of the cable 4 takes place. In order to absorb the operational variation, the guide slot 31 of the arm 30 according to an exemplary embodiment of the present invention is provided with the first door idling section 31a and the second door idling section 31b.

That is, since the distances that the cable 4 moves when being pulled and when being returned are different, operational variations are caused in the cable 4. Accordingly, if the operational variation of the cable 4 is not absorbed, the rotational control of the door 15 becomes incorrect and a result in a malfunction of the air conditioning system.

Accordingly, the present invention has a configuration in which the guide slot 31 formed in the arm 30 includes the first and second door idling sections 31a, 31b in order to sufficiently absorb the operational variation of the cable 4.

In the first and second door idling sections 31a, 31b, even if the cam plate 20 rotates, the arm does not rotate and thus the door 15 also does not rotate. Accordingly, it is possible to prevent undesired rotational operation of the door 15.

In the air conditioning system according to an exemplary embodiment of the present invention, the regulating knob 2 is operated to rotate the cam plate 20. Also, the rotation of the cam plate 20 directly rotates the arm 30 to cause the door shaft 13 and the door 15 to rotate.

Accordingly, in the air conditioning system according to an exemplary embodiment of the present invention, the cam plate 20 and the arm 30 are directly connected to each other without using the lever 8 employed in conventional air conditioning system. It is therefore possible to reduce the weight and price thereof as well as the number of parts that are used.

Further, in the air conditioning system according to an exemplary embodiment of the present invention, the route over which power is transmitted from the regulating knob 2 to the arm 30 is made the shortest possible to minimize the quantity of transmitted power that is lost. As a result, there is an effect that the operational control of the door 15 becomes more correct.

Meanwhile, when the cam pivot 21 moves within a range of the first and second door idling sections 31a, 31b as the cam plate 20 rotates about the cam shaft 5, a rotational force of the cam plate 20 is not transmitted to the arm 30 and thus the arm 30 does not rotate.

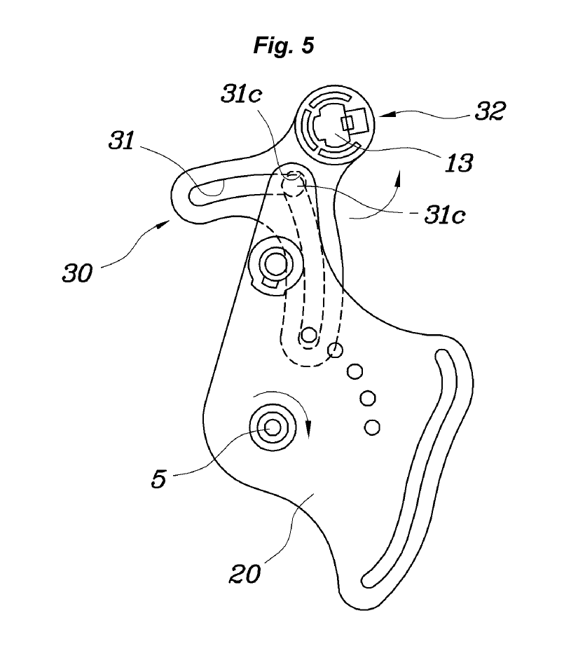

However, when the cam pivot 21 moves along the guide slot 31 and then is inserted into the cam pivot seating groove 31c, as shown in FIG. 5, the rotational force of the cam plate 20 is transmitted to the arm 30 from this time.

If the cam plate 20 is rotated in such a state, the rotational force of the cam plate 20 is entirely transmitted to the arm 30 without any power loss, thereby causing the arm 30 to be rotated. Also, since the rotation of the arm 30 causes the door shaft 13 and the door 15 to rotate, it is possible to regulate the extent to which the vent hole 14 is opened by the door 15.

Accordingly, in the air conditioning system according to an exemplary embodiment of the present invention, since friction between the cam plate 20 and the arm 30 can be avoided when the rotational force of the cam plate 30 is transmitted to the arm 30, it is possible to eliminate the loss of power due to friction.

Further, since friction between the cam plate 20 and the arm 30 can be avoided, it is possible to significantly reduce the operational energy expenditure.

As is apparent from the above description, advantages of the vehicular air conditioning system according to an exemplary embodiment of the present invention are that, since friction between the cam plate and the arm can be avoided when the rotational force of the cam plate is transmitted to the arm, it is possible to eliminate a power loss and significantly reduce the operational energy expenditure. Also, according to an exemplary embodiment of the present invention, since a route over which power is transmitted from the regulating knob to the arm can be minimized, it is possible to minimize the quantity of transmitted power that is lost. Furthermore, since the cam plate and the arm are directly connected to each other, it is also possible to reduce the number of used parts as well as the weight and price thereof.

For convenience in explanation and accurate definition in the appended claims, the terms “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicular air conditioning system comprising:
a cam plate rotatably coupled to an air conditioning case via a cam shaft, wherein a portion of the cam plate is connected to a regulating knob via a cable for selecting an air conditioning mode and wherein a portion of the cam plate is integrally formed with a cam pivot projecting toward the air conditioning case; and
an arm rotatably coupled to the air conditioning case via a door shaft and formed with a guide slot into which the cam pivot is inserted,
wherein the arm is configured to rotate about the door shaft while the cam pivot pushes a portion of the guide slot as the cam plate rotates.

2. The vehicular air conditioning system according to claim 1, wherein the arm includes:
a central part to which the door shaft is coupled; and
a first leg and a second leg which branch off from the central part, and
wherein the guide slot extends from an end of the first leg in a longitudinal direction of the first leg to an end of the second leg along a longitudinal direction of the second leg.

3. The vehicular air conditioning system according to claim 2, wherein the guide slot includes:
a first door idling section formed in an arc shape to have a constant curvature along the longitudinal direction of the first leg;
a second door idling section formed in an arc shape to have a constant curvature along the longitudinal direction of the second leg; and
a cam pivot seating groove recessing from a connecting part of the first door idling section and the second door idling sections toward the central part.

4. The vehicular air conditioning system according to claim 3, wherein the size of the cam pivot seating groove is set to allow the cam pivot to be inserted therein, and wherein the cam pivot is selectively received in the cam pivot seating groove in accordance with a rotation angle of the cam shaft.

5. The vehicular air conditioning system according to claim 2, wherein the first leg and the second leg branch off in opposite directions from the central part with a predetermined angle therebetween.
